(19) United States
(12) Patent Application Publication
(10) Pub. No.: US 2025/0133125 A1
(43) Pub. Date: Apr. 24, 2025

(54) COMPUTER-BASED SYSTEMS CONFIGURED TO DELAY PROCESSING OF STREAMING CONTENT BY UTILIZING MULTI-QUEUE TECHNOLOGY AND METHODS OF USE THEREOF

(71) Applicant: Capital One Services, LLC, McLean, VA (US)

(72) Inventors: Venkateshwar Parpelli, Frisco, TX (US); Luke Kiowski, Chicago, IL (US); Yang Chen, McLean, VA (US)

(21) Appl. No.: 18/491,471

(22) Filed: Oct. 20, 2023

(51) Int. Cl. H04L 65/612; H04L 65/80

(52) U.S. Cl. CPC H04L 65/612; H04L 65/80

(57) ABSTRACT

In certain embodiments, a system and accompanying method to delay processing of streaming content by utilizing multi-queue technology is provided. In particular, the system receives, at a first function, a streaming record associated with an event. The first function places the streaming record into a delay queue with a delay timestamp according to the type of the event associated with the streaming record. Operation of a second function is triggered and the second function determines if a current time is greater than the delay for a delay timestamp for the streaming record. The second function requeues the streaming record into the delay queue if the current time is less than the delay. If the current time is greater than the delay, the second function places the streaming record into a ready queue for processing. The second function processes the streaming record in the ready queue.

### FIELD OF TECHNOLOGY

The present disclosure generally relates to computer-based systems configured to delay processing of streaming content by utilizing multi-queue technology and methods of use thereof.

### BACKGROUND OF TECHNOLOGY

Computing systems utilize a variety of different technologies to process content. Typically, content is processed as the content arrives to the computing systems, however, in certain scenarios, schedulers are utilized to process content on a schedule. While existing computing systems for scheduling processing of content exist, such existing computing systems are incapable of being integrated with content streams and are typically focused on the amount of computing resources being used to process the content.

### SUMMARY OF DESCRIBED SUBJECT MATTER

In certain embodiments, the present disclosure provides an exemplary system for delaying processing of streaming records by utilizing multi-queue technology. In certain embodiments, the system may include a memory that stores instructions and a processor that executes the instructions to cause the processor to be configured to receive, by a first function, one or more streaming records, wherein each streaming record of the one or more streaming records may be associated with an event. In certain embodiments, the processor may be configured to place, by the first function, the one or more streaming records in a delay queue with a delay timestamp according to a type of the event associated with the one or more streaming records. In certain embodiments, the processor may be configured trigger, in response to placing the one or more streaming records in the delay queue, operation of a second function. In certain embodiments, the processor may be configured to determine, by the second function, if a current time is greater than the delay timestamp for the one or more streaming records. In certain embodiments, the processor may be configured to requeue, by the second function, the one or more streaming records into the delay queue if the current time is determined to be less than the delay timestamp. In certain embodiments, the processor may be configured to place, by the second function, the one or more streaming records into a ready queue if the current time is determined to be equal to or greater than the delay timestamp. In certain embodiments, the processor may be configured to process the one or more streaming records in the ready queue.

In certain embodiments, the processor may be configured to determine whether the type of the event is an initialization event, a success event, or a recommendation event. In certain embodiments, the processor may be configured to place the one or more streaming records in the delay queue if the type of event is the initialization event or the success event. In certain embodiments, the processor may be configured to prevent the one or more streaming records from being placed in the delay queue if the type of event is a recommendation event or other event for which the one or more streaming records should not be placed in the delay queue or should not be processed. In certain embodiments, the processor may be configured to group the one or more streaming records with one or more other streaming records based on the one or more other streaming records corresponding to the type of the event associated with the one or more streaming records. In certain embodiments, the processor may be configured to trigger, after requeuing the one or more streaming records into the delay queue when the current time is determined to be less than the delay timestamp, the second function to redetermine if a new current time is greater than the delay timestamp for the one or more streaming records.

In certain embodiments, the processor may be configured to establish a setting specifying the delay timestamp for the type of the event. In certain embodiments, the processor may be configured to receive a request to modify the setting specifying the delay timestamp for the type of the event. In certain embodiments, the processor may be configured to modify the setting to specify a modified delay timestamp for the type of the event based on the request. In certain embodiments, the processor may be configured to delay the triggering of the operation of the second function performed in response to placing the one or more streaming records in the delay queue in accordance with the delay indicated by the delay setting. In certain embodiments, the event may be associated with a digital communication to attract a user into subscribing to a product or service, perform an action, or a combination thereof. In certain embodiments, the processor may be configured to determine an effectiveness of a digital communication in facilitating interaction by a user with a product or service based on processing the at least one streaming record associated with the event. In certain embodiments, the processor may be configured to modify the digital communication based on the effectiveness of the digital communication to generate a modified digital communication. In certain embodiments, the processor may be configured to transmit the modified digital communication to the user, another user, or a combination thereof.

In certain embodiments, the present disclosure provides an exemplary computer-implemented method for delaying processing of streaming records by utilizing multi-queue technology. In certain embodiments, the method may be performed by utilizing a processor and/or other computer technology. In certain embodiments, the method may include receiving, by a first function and by utilizing a processor, one or more streaming records, wherein each streaming record of the one or more streaming records is associated with an event. In certain embodiments, the method may include placing, by the first function and by utilizing the processor, the one or more streaming records in a delay queue with a delay timestamp according to a type of the event associated with the one or more streaming records. In certain embodiments, the method may include triggering, in response to placing the one or more streaming records in the delay queue and by utilizing the processor, operation of a second function. In certain embodiments, the method may include determining, by the second function and by utilizing the processor, if a current time is greater than the delay timestamp for the one or more streaming records. In certain embodiments, the method may include requeuing, by the second function and by utilizing the processor, the one or more streaming records into the delay queue if the current time is determined to be less than the delay timestamp. In certain embodiments, the method may include placing, by the second function and by utilizing the processor, the one or more streaming records into a ready queue if the current time is determined to be equal to or greater than the delay timestamp. In certain embodiments, the method may include processing, by the processor, the one or more streaming records in the ready queue.

In certain embodiments, the method may include determining the type of the event associated with the one or more streaming records. In certain embodiments, the method may include triggering, after requeuing the one or more streaming records into the delay queue when the current time is determined to be less than the delay timestamp, the second function to redetermine if a new current time is greater than the delay timestamp for the one or more streaming records. In certain embodiments, the method may include specifying a delay for the second function that indicates when to trigger the operation of the second function. In certain embodiments, the method may include preventing the one or more streaming records from being placed in the delay queue if the type of event is a recommendation event. In certain embodiments, the method may include placing the one or more streaming records from in the delay queue if the type of event is an initialization event or a success event. In certain embodiments, the method may include triggering the operation of the first function, the second function, or a combination thereof, based on a preference.

In some embodiments, the present disclosure provides an exemplary non-transitory computer-readable medium comprising computer instructions, which, when loaded and executed by a processor, cause the processor to be configured to: receive, by a first function, at least one streaming record, wherein each streaming record of the at least one streaming record is associated with an event; place, by the first function, the at least one streaming record in a delay queue with a delay timestamp according to a type of the event associated with the at least one streaming record; trigger, in response to placing the at least one streaming record in the delay queue, operation of a second function; determine, by the second function, if a current time is greater than the delay timestamp for the at least one streaming record; requeue, by the second function, the at least one streaming record into the delay queue if the current time is determined to be less than the delay timestamp; place, by the second function, the at least one streaming record into a ready queue if the current time is determined to be equal to or greater than the delay timestamp; and process the at least one streaming record in the ready queue.

### BRIEF DESCRIPTION OF DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 depicts a block diagram of an exemplary computer-based system and platform for delaying processing of streaming records by utilizing multiple queues, in accordance with one or more embodiments of the present disclosure.

FIG. 2 is a block diagram illustrating a process flow for delaying processing of streaming records by utilizing multiple queues, in accordance with one or more embodiments of the present disclosure.

FIG. 3 is a block diagram illustrating operational steps for delaying processing of streaming records by utilizing multiple queues, in accordance with one or more embodiments of the present disclosure.

FIG. 4 depicts a block diagram of exemplary computer-based system/platform in accordance with one or more embodiments of the present disclosure.

FIG. 5 depicts a block diagram of another exemplary computer-based system/platform in accordance with one or more embodiments of the present disclosure.

FIGS. 6 and 7 are block diagrams illustrating implementations of cloud computing architecture/aspects with respect to which the disclosed technology may be specifically configured to operate, in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in certain embodiments,” “in another embodiment,” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a creator interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, daily, several days, weekly, monthly, etc.

As used herein, the term “runtime” corresponds to any behavior that is dynamically determined during an execution of a software application or at least a portion of software application.

At least some embodiments of the present disclosure provide technological solution(s) to at least one technological computer-centered problem associated with processing streaming content, such as streaming records, to more accurately determine whether recommendations for features, products, and/or services are effective. Typically, the problem arises when information associated with software features, new products and services, or updated products and services are delivered or otherwise made available to users. For example, an entity, such as a business, may deliver a physical mailing or a digital electronic mail (i.e., an email) to a user recommending a new product or service provided by the entity. In order to accurately determine whether the business's electronic mail campaign is successful in getting users to initialize subscription to the recommended product or service and/or interact with the product or service in some manner, there may be a business or other requirement that indicates that at least a certain period of time delay must occur after the digital electronic mail is provided before processing streaming records that are associated with a user's acceptance of or interactions with the recommended product or service. Despite the foregoing, existing technologies process streaming records as soon as they are generated. For example, as soon as a user generates feedback on a recommended service, a record that is generated that is associated with the feedback, is immediately processed by a system. As another example, a user may initially provide negative feedback on the recommended service, but the user may change his preference a few days later (e.g., within the delay time period). As a further example, the physical mailing may not have arrived at the user's residence yet, which without waiting for the required delay period, conducting immediate processing of an associated record may indicate that the mailing was not successful. Based on at least the foregoing, existing technologies that provide immediate or continuous processing of records may do not effectively account for business or other requirements that may require delays. Additionally, existing technologies are incapable of processing streams of records These technological computer-centered problems may result in inaccurate assessments of marketing campaigns, insufficient time for users to interact with campaigns, and inflexibility.

As detailed in at least some embodiments herein, at least one technological computer-centered solution addressing the technological computer-centered problem may be to utilize multiple queues to delay processing of streaming content, such as streaming records. In certain embodiments, the present disclosure details that one practical solution may be to receive one or more streaming records by a first function, where the streaming records are associated with an event, such as, but not limited to, a recommendation event, an initialization event, a success event, among other types of events. The first function may place the one or more streaming records into a delay queue with a delay timestamp according to the type of the event associated with each of the one or more streaming records. In response to placing the one or more streaming records in the delay queue, the operation of a second function may be triggered. The second function may determine if a current time is greater than the delay timestamp for a particular streaming record. For example, the determination may involve comparing the current time to the elapsed portion of the time delay (i.e., the time delay specified by the delay timestamp) added to the time at which the streaming record was added into the delay queue. If the current time is determined to be less than the delay (i.e., the delay based on the delay timestamp) that has elapsed since the streaming record was placed in the delay queue, the second function may requeue the streaming record into the delay queue. If, however, the current time is determined to be at least as great as the delay timestamp added to the time at which the record entered the delay queue, the second function can place the streaming record into a ready queue so that the record can be processed in accordance with the requirements of the campaign.

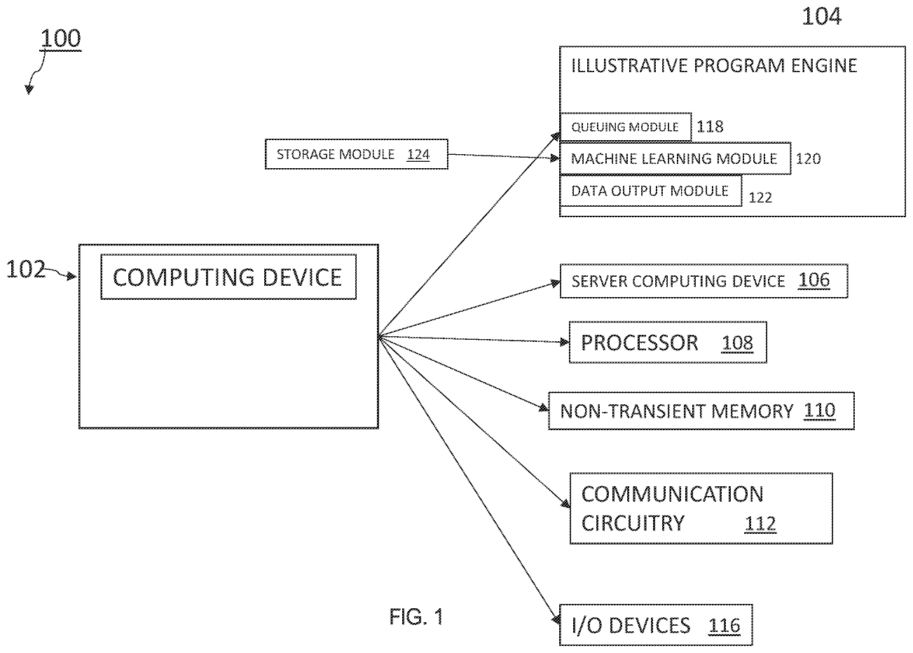

FIG. 1 depicts a block diagram of an exemplary computer-based system and platform for delaying processing of streaming records by utilizing multiple queues, in accordance with one or more embodiments of the present disclosure.

In certain embodiments, an illustrative computing system 100 of the present disclosure may include at least one computing device 102 associated with at least one user and an illustrative program engine 104. In certain embodiments, the illustrative program engine 104 may be stored on the computing device 102. In some embodiments, the illustrative program engine 104 may be executed on the computing device 102 or a server computing device 106, a processor 108 to perform operations of the system 100, a non-transient memory 110 configured to store data, commands, and/or instructions, a communication circuitry 112 for facilitating and/or enabling communication over a communication network 114 (not shown), and input and/or output (I/O) devices 116 such as a keyboard, mouse, a touchscreen, and/or a display, for example. In certain embodiments, the computing device 102 may refer to at least one communicative computing device of a plurality of communicative computing devices. In certain embodiments, the server computing device 106 may be an external data source that is considered hardware. In certain embodiments, the server computing device 106 may consist of a plurality of software engines to perform a variety of actions. In certain embodiments, the computing device 102 may be considered the server computing device 106. For example, the computing device 102 may be a digital credit card, a smart credit card, a smart phone, a mobile device, a wearable device, a computer, a sensor, and/or a laptop. In certain embodiments, the computing device 102 may have an ability to execute a plurality of actions, such as, but not limited to, receiving streaming records associated with events by a first function, placing the streaming records in delay queues with delay timestamps according to a type of event (e.g., an event associated with a product or service), triggering operation of a second function after placing the streaming record in the delay queue, requeuing the streaming record into the delay queue if the current time is less than the delay timestamp added to the time at which the streaming record was placed into the delay queue (or at any other desired reference time), placing the streaming record into a ready queue if the current time is determined to be equal to or greater than the time elapsed from the time at which the streaming record was placed in the delay queue plus the delay timestamp, processing the streaming records in the delay queue, performing any other actions of the present disclosure, or a combination thereof. In certain embodiments, the server computing device 106 may utilize software engines to perform the plurality of actions.

In some embodiments, the illustrative program engine 104 may be configured to instruct the processor 108 to execute one or more software modules such as, without limitation, an exemplary queuing module 118, a machine learning module 120, a data output module 122, and/or any other modules, programs, and/or functions.

In certain embodiments, an exemplary queuing module 118 of the present disclosure may be configured to receive streaming records associated with events that may be associated with a product, service, and/or feature. In certain embodiments, the queueing module 118 may be configured to contain and/or utilize any number of functions, such as queueing functions that may be utilized to queue streaming records arriving at the computing system 100. In certain embodiments, the queueing module 118 may be configured to analyze the streaming records that arrive at the computing system 100. For example, the queueing module 118 may analyze each streaming record to determine various types of information, such as, but not limited to, information identifying a user that is the target of a product, service, and/or feature, information identifying the type of event associated with the product, service, and/or feature, information identifying a device of the user, information identifying a time and/or type of interaction conducted with respect to the product, service, and/or feature, information identifying the product, service, and/or feature, any other information, or a combination thereof. In certain embodiments, the queueing module 118 may be utilized to add a delay timestamp to each streaming record based on the type of event determined to be associated with the streaming record. In certain embodiments, the delay timestamp may be a few seconds, minutes, days, weeks, months, or other time duration that may be added to the time at which a streaming record is added to the delay queue. In certain embodiments, the delay timestamp may be added to the time at which the streaming record is generated rather than when the streaming record is placed in the delay queue. Once the delay timestamp is added to each streaming record, a first queueing function may place the streaming record into a delay queue.

In certain embodiments, once a streaming record is placed into the delay queue, operation of a second queueing function may be triggered by the system 100 at such time or at other selected times. The second queueing function can analyze the current time and compare it to the elapsed portion of the time delay specified by the delay timestamp since the streaming record was placed into the delay queue. If the current time is less than the elapsed portion of the time delay, the second queueing function may place the streaming record back into the delay queue so that the streaming record can be analyzed again as time progresses. If, however, the current time is greater than or equal to the elapsed portion of the time delay, the second queueing function may place the streaming record into a ready queue for processing. As each streaming record is placed in the ready queue, the streaming record may be processed, such as to determine the effectiveness of a campaign associated with a product, service, and/or feature. In certain embodiments, the system 100 may utilize at least one trained machine learning module 120, described herein, to directly place or facilitate the placement of the streaming records into queues, perform the determinations as to whether a streaming record is to be requeued into the delay queue or placed in the ready queue for processing, and/or performing any of the other operations of the present disclosure. In certain embodiments, the queueing module 118 may dynamically store into a storage module 124 associated with the computing device 102 the streaming records, metadata describing the streaming records (e.g., metadata indicating whether the streaming record is in a delay queue or the ready queue for processing, metadata indicating the type of event, the type of product, service, and/or feature, any other metadata, or a combination thereof), results of processing the streaming records (e.g., whether a campaign was effective or not, identifying which users accepted a recommendation and ultimately interacted with the products, services, and/or features, etc.), or a combination thereof.

In certain embodiments, the present disclosure describes systems for utilizing the machine learning module 120 to facilitate and/or perform any of the operations of the computing system 100. For example, the machine learning module 120 can utilize neural networks, support vector machines, logistic regressions, linear regressions, regression analysis, statistical classification, cluster analysis, artificial intelligence, and/or other forms of machine learning to place streaming records into delay queues, trigger operation of functions, requeue streaming records, placing the streaming records into ready queues for processing, and process the streaming records in the ready queue. In certain embodiments,

In some embodiments, the non-transient computer memory 110 may store an output of an operation performed by the computing device 102. In certain embodiments, the output may refer to performing the operation and/or generating instructions to execute operation of the queuing functions, processing the streaming records, and/or performing other operations. In certain embodiments, the non-transient computer memory 110 may store processing results that are obtained when processing the streaming records, store timestamps for each type of event, store functions (e.g., the lambda queueing functions), store feedback received from users, store any other information described in the present disclosure, or a combination thereof. In certain embodiments, the non-transient computer memory 110 may store trend information indicating which products, features, and/or services are being initialized or interacted with by users, and which are being ignored by users. In some embodiments, the non-transient computer memory 110 may store a result of a utilization of the machine learning module 120 to place streaming records into the delay queue or the ready queue, utilize delay timestamps with streaming records, analyze feedback from users, or a combination thereof. In certain embodiments, the non-transient computer memory 110 may store a plurality of instructions to transmit a plurality of data from the computing device 102 to an external data source, such as for further processing of the records, feedback from users, or a combination thereof. In some embodiments, the non-transient computer memory 110 may store a dynamically update to a storage module 124 associated with the computing device 102 with metadata based on a transmission of data in response to the execution of operations of the system 100. In certain embodiments, the non-transient computer memory 110 may store a prediction of a plurality of trends associated with interaction with products, services, and/or features by users, and predictions associated with whether a recommended product, service, and/or feature will be initialized by a user.

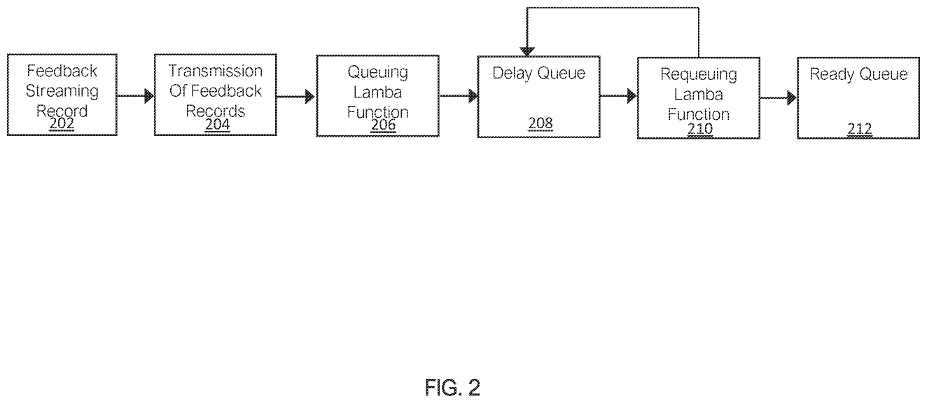

FIG. 2 is a block diagram illustrating a process flow 200 for delaying processing of streaming records by utilizing multiple queues, in accordance with one or more embodiments of the present disclosure.

At 202 of the process flow 200, the illustrative program engine 104, which may be within the computing device 102, may be configured to receive one or more streaming records that may be associated with events that are associated with products, features, and/or services that may be provided by an entity. In certain embodiments, the streaming records may contain information identifying a user that is the target of the product, service, and/or feature, information identifying the type of event, information identifying a time and/or type of interaction conducted with respect to the product, service, and/or feature and/or recommendation (e.g., a recommendation provided by a digital marketing via email, push notification, and/or other technologies), information identifying the product, service, and/or feature, information identifying the type of recommendation made to a user (e.g., for a product or service and/or the type of, feedback from a user that is associated with the product, feature, and/or service, any other information, or a combination thereof. At 204, the process flow may include transmitting the streaming records to a first queuing function (e.g., a lambda function). At 206, the first queueing function may be configured to place each streaming record into a delay queue with a delay timestamp corresponding with the type of event, product, feature, service, or a combination thereof. In certain embodiments, at 208, when a streaming record is placed into the delay queue, a second queuing function may be triggered. In certain embodiments, the triggering may be performed by the delay queue itself, the first queueing function, other components of the computing device 102, or a combination thereof. In certain embodiments, the triggering may be according to a preference, such as a preference for a specific time, a preference regarding the type of event, product, features, and/or service, a preference regarding time of day, any type of preference, or a combination thereof.

At 210, the second queueing function (i.e., the second lambda function) may analyze each streaming record from the delay queue and determine whether the current time is greater than the time delay (i.e., specified by the delay timestamp) added to the posted time of the streaming record upon entry into the delay queue. If the current time is greater than the time delay, the second queueing function may, at 212, place the corresponding streaming record into a ready queue so that the streaming record can be processed. If, however, the current time is not greater than the time delay, the second queueing function may requeue the streaming record and place the streaming record back into the delay queue, at 208. The process may be repeated until the current time is at least as great as the time delay. In certain embodiments, once the streaming records are processed from the ready queue, the information gleaned from the processing may be utilized to inform those associated with the entity regarding the effectiveness of recommendations to users (e.g., such as via digital communications to the users).

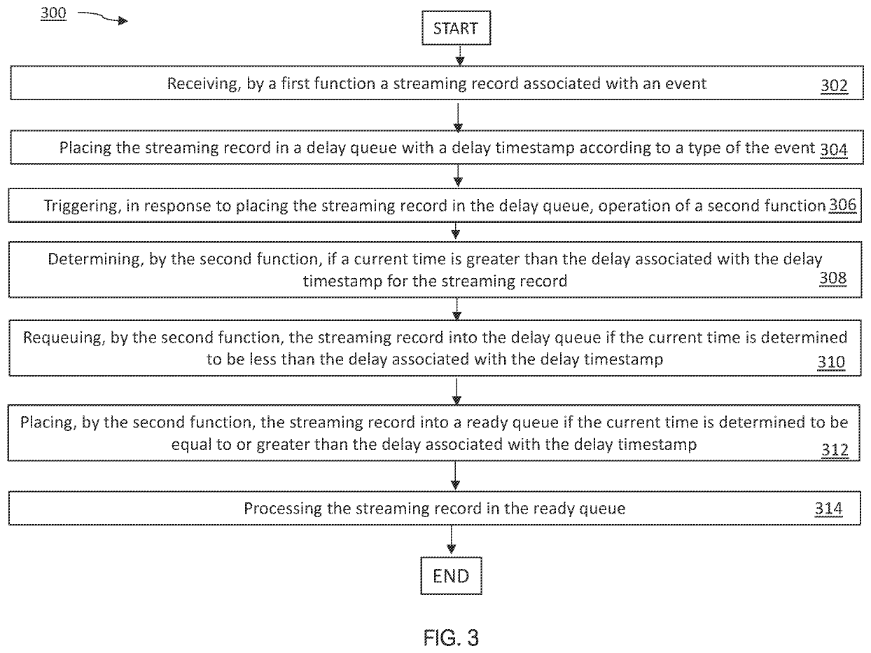

FIG. 3 is a flowchart of a method 300 illustrating operational steps for delaying processing of streaming records by utilizing multiple queues, in accordance with one or more embodiments of the present disclosure.

In step 302, the illustrative program engine 104 (or other components) within the computing device 102 may receive one or more streaming records, which may be associated with events. In certain embodiments, the streaming records may be received by a first function (e.g., a lambda function) of the illustrative program engine 104. In certain embodiments, for example, the streaming records may include any type of information associated with an event that may be associated with a product, service, feature, or a combination thereof. For example, the streaming record may contain information identifying a user that is the target of the product, service, and/or feature, information identifying the type of event, information identifying a time and/or type of interaction conducted with respect to the product, service, and/or feature, information identifying the product, service, and/or feature, any other information, or a combination thereof. In certain embodiments, the event may be any type of event, such as a recommendation event, an initialization event, a success event, any other type of event, or a combination thereof. In certain embodiments, a recommendation event may include, but is not limited to, a recommendation of a product, service, and/or feature for a user to interact with and potentially purchase or subscribe to. In certain embodiments, the recommendation event can be requested by an application that the user is interacting with and can be provided by the system 100 and/or other components of the Figures. In certain embodiments, an initialization event may be when a user has accepted a recommendation, but has not yet interacted with the recommended product, service, and/or feature. In certain embodiments, a success event may be when a user has successfully interacted with the recommended product, service, and/or feature.

In step 304, the illustrative program engine 104 can place the streaming records into a delay queue, along with delay timestamps for each streaming record based on the type of event that is associated with each streaming record and/or the product, service, and/or feature. In certain embodiments, the placing of the streaming records into the delay queue may be performed by utilizing the queuing module 118 of the program engine 104, which may contain a first function (e.g., a lambda function) that may perform the placement. In certain embodiments, the delay timestamps can be identified and/or selected for each streaming record by the program engine 104 (i.e., via first function) based on a detection of the type of event, product, service, and/or feature. In certain embodiments, certain types of streaming records can be prevented from being placed in the delay queue. For example, streaming records associated with recommendation events can be prevented from entering the delay queue, however, streaming records associated with initialization events or success events may be placed in the delay queue. In certain embodiments, once a streaming record is placed into the delay queue, the method 300 may proceed to step 306. At step 306, the illustrative program engine 104 can trigger or facilitate triggering operation of a second function (i.e., a second lambda function) of the illustrative program engine 104 (or other component of the computing device 102). In certain embodiments, the triggering or the facilitating of the triggering may be in response to the placement of a streaming record into the delay queue.

At step 308, the second function may analyze a streaming record from the delay queue and determine whether the current time is greater than the time elapsed from the creation of the streaming record plus the delay timestamp added to the record for the type of event associated with the streaming record. If the second function determines that the current time is less than the time specified by the delay timestamp for the streaming record, the second function may requeue the streaming record back into the delay queue, at step 310. In certain embodiments, steps 308 and 310 can be repeated until the If, however, the second function determines that current time is at least as great as the time elapsed from the creation of the streaming record plus the delay timestamp added to the streaming record, the second function may place the streaming record into a ready queue for processing, at step 312. At 314, the streaming record in the ready queue can be processed by any of the modules, programs, and/or components of the computing device 102. In certain embodiments, the second function can be utilized to process the streaming record and/or facilitate processing of the streaming record. In certain embodiments, the method 300 can be repeated continuously, on a periodic basis, or at designated times or time periods. In certain embodiments, batches of streaming records may be grouped according to type and may be processed in batches if the time elapsed from the delay of the delay timestamp is greater than or equal to the current time.

In an exemplary use-case scenario, an entity (e.g., a bank or other entity) may be deploying software features on a web application utilized by its users. The entity may generate a recommendation for a subset of the users to utilize the new software features or subscribe to the new software features because the feature may provide enhanced functionality and optimization for the user's experience with the web application of the entity. The recommendation, for example, may be provided in the form of a digital communication, a physical mailing, an in-person recommendation by an agent of the entity, and/or other form. In certain embodiments, the recommendation may be provided by a software program, such as a digital avatar interacting with the user via the web application or website. Streaming records can be generated for the recommendations themselves, when a user accepts a recommendation (i.e., initialization event), and/or when a user interacts with the software features (i.e., success event). The streaming records can identify the user, the type of event (e.g., recommendation, initialization, success, or other event), a time at which the event occurred, an acceptance occurred, and/or an interaction occurred, feedback provided by a user (e.g., whether the user had a positive or negative experience or did not interact with the recommended product, service, and/or features), any other information of the present disclosure, or a combination thereof.

As the streaming records are generated, the computing device 102 may receive the streaming records and each streaming record can be placed in a delay queue for delaying processing of the streaming records, along with a delay timestamp. The streaming records may be placed in the delay queue by a first function. Once streaming records are placed in the delay queue, the delay queue or other components of the system 100 can trigger operation of a second function that can determine whether a current time is greater than or equal to a delay specified by a delay timestamp for each streaming record. If the current time is less than the delay, the second function can requeue the streaming record and repeat the process until the current time is greater than or equal to the delay specified by the timestamp. When the current time is greater than or equal to the delay, the second function can place the streaming record into a ready queue for processing. The streaming records in the ready queue can be processed immediately.

The foregoing functionality assists entities in ensuring that recommendations are provided with the appropriate time duration for a user to receive a recommendation, accept or reject the recommended product, services, and/or features, and successfully interact with the product, services, and/or features. For example, if a physical mailing is sent out, streaming records associated with such a physical mailing may need to be processed after 8 days (i.e., the delay associated with the digital timestamp) to ensure that enough time was provided for the user to receive the mailing, view the mailing, and/or interact with the mailing. However, for a digital communication, the delay timestamp may be much lower, such as 1 day. By incorporating delay timestamps to dictate when streaming records are processed, the effectiveness of the recommendation can be more accurately determined.

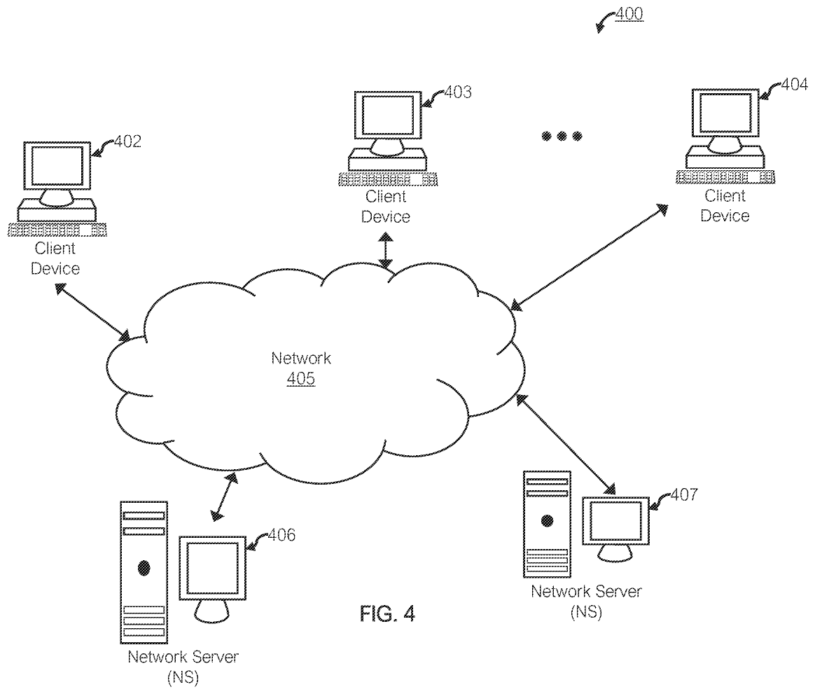

FIG. 4 depicts a block diagram of an exemplary computer-based system/platform 400 in accordance with one or more embodiments of the present disclosure. However, not all of these components may be required to practice one or more embodiments, and variations in the arrangement and type of the components may be made without departing from the spirit or scope of various embodiments of the present disclosure. In certain embodiments, the exemplary inventive computing devices and/or the exemplary inventive computing components of the exemplary computer-based system/platform 400 may be configured to delay processing of streaming records by utilizing multiple queues, as detailed herein. In certain embodiments, the exemplary computer-based system/platform 400 may be based on a scalable computer and/or network architecture that incorporates various strategies for queuing streaming records for processing through the use of delay timestamps that are utilized to delay processing of the streaming records until the delay specified through the delay timestamps is satisfied. An example of the scalable architecture is an architecture that is capable of operating multiple servers. In some embodiments, the exemplary inventive computing devices and/or the exemplary inventive computing components of the exemplary computer-based system/platform 400 may be configured to manage the exemplary queuing module 118 of the present disclosure, such as by utilizing at least one machine-learning model described herein.

In certain embodiments, referring now also to FIG. 4, members 402-404 (e.g., clients) of the exemplary computer-based system/platform 400 may include virtually any computing device capable of generating, transmitting, and/or receiving streaming records (and/or performing any other operations of the present disclosure) via a network (e.g., cloud network), such as network 405, to and from another computing device, such as servers 406 and 407, each other, and the like. In certain embodiments, the member devices 402-404 may be personal computers, multiprocessor systems, microprocessor-based or programmable consumer electronics, network PCs, and the like. In some embodiments, one or more member devices within member devices 402-404 may include computing devices that connect using a wireless communications medium such as cell phones, smart phones, pagers, walkie talkies, radio frequency (RF) devices, infrared (IR) devices, CBS, integrated devices combining one or more of the preceding devices, or virtually any mobile computing device, and the like. In some embodiments, one or more member devices within member devices 402-404 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 402-404 may include may launch one or more applications, such as Internet browsers, mobile applications, voice calls, video games, videoconferencing, and email, among others. In some embodiments, one or more member devices within member devices 402-404 may be configured to receive and to send web pages, and the like. In some embodiments, an exemplary beacon locator module 118 of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 402-404 may be specifically programmed by either Java, .Net, QT, C, C++ and/or other suitable programming language. In some embodiments, one or more member devices within member devices 402-404 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In certain embodiments, the exemplary network 405 may provide network access, data transport and/or other services to any computing device coupled to it. In certain embodiments, the exemplary network 405 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 405 may implement one or more of a GSM architecture, a General Packet Radio Service (GPRS) architecture, a Universal Mobile Telecommunications System (UMTS) architecture, and an evolution of UMTS referred to as Long Term Evolution (LTE). In certain embodiments, the exemplary network 405 may include and implement, as an alternative or in conjunction with one or more of the above, a WiMAX architecture defined by the WiMAX forum. In certain embodiments and, optionally, in combination of any embodiment described above or below, the exemplary network 405 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In certain embodiments and, optionally, in combination of any embodiment described above or below, at least one computer network communication over the exemplary network 405 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 405 may also include mass storage, such as network attached storage (NAS), a storage area network (SAN), a content delivery network (CDN) or other forms of computer or machine-readable media.

In certain embodiments, the exemplary server 406 or the exemplary server 407 may be a web server (or a series of servers) running a network operating system, examples of which may include but are not limited to Microsoft Windows Server, Novell NetWare, or Linux. In certain embodiments, the exemplary server 406 or the exemplary server 407 may be used for and/or provide cloud and/or network computing. Although not shown in FIG. 4, in some embodiments, the exemplary server 406 or the exemplary server 407 may have connections to external systems like email, SMS messaging, text messaging, ad content providers, etc. Any of the features of the exemplary server 406 may be also implemented in the exemplary server 407 and vice versa.

In some embodiments, one or more of the exemplary servers 406 and 407 may be specifically programmed to perform, in non-limiting example, as queuing servers, authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 401-404.

In certain embodiments and, optionally, in combination of any embodiments described above or below, for example, one or more exemplary computing member devices 402-404, the exemplary server 406, and/or the exemplary server 407 may include a specifically programmed software module that may be configured to receive, by a first function, one or more streaming records associated with an event that may be associated with a product, service, and/or feature; place the one or more streaming records into a delay queue with a delay timestamp; trigger operation of a second function in response to placing the one or more streaming records in the delay queue; determine whether a current time is greater than the time delay associated with the delay timestamp for each streaming record; requeuing, by a second function, a streaming record if the current time is determined to be less than the delay; place, by the second function, a streaming record into a ready queue if the current time is greater than or equal to the delay; and processing the streaming records in the ready queue.

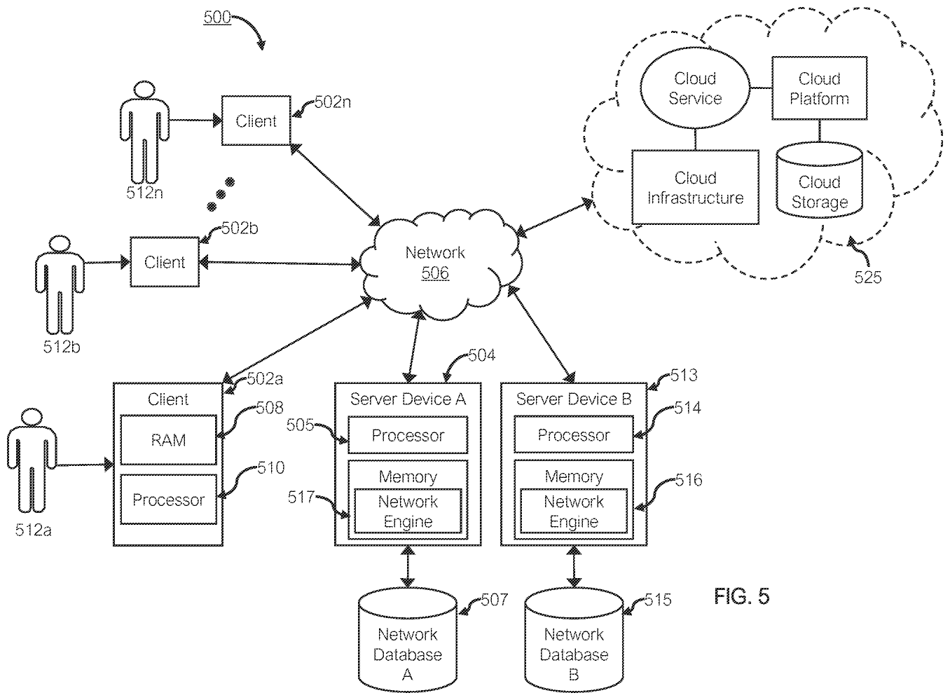

FIG. 5 depicts a block diagram of another exemplary computer-based system/platform 500 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices 502a, 502b thru 502n shown each at least includes a computer-readable medium, such as a random-access memory (RAM) 508 coupled to a processor 510 or FLASH memory. In certain embodiments, the processor 510 may execute computer-executable program instructions stored in memory 508. In some embodiments, the processor 510 may include a microprocessor, an ASIC, and/or a state machine. In certain embodiments, the processor 510 may include, or may be in communication with, media, for example computer-readable media, which stores instructions that, when executed by the processor 510, may cause the processor 510 to perform one or more steps described herein. In certain embodiments, examples of computer-readable media may include, but are not limited to, an electronic, optical, magnetic, or other storage or transmission device capable of providing a processor, such as the processor 510 of client 502a, with computer-readable instructions. In certain embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In certain embodiments, member computing devices 502a through 502n may also comprise a number of external or internal devices such as a mouse, a CD-ROM, DVD, a physical or virtual keyboard, a display, a speaker, or other input or output devices. In some embodiments, examples of member computing devices 502a through 502n (e.g., clients) may be any type of processor-based platforms that are connected to a network 506 such as, without limitation, personal computers, digital assistants, personal digital assistants, smart phones, pagers, digital tablets, laptop computers, Internet appliances, and other processor-based devices. In certain embodiments, member computing devices 502a through 502n may be specifically programmed with one or more application programs in accordance with one or more principles/methodologies detailed herein. In certain embodiments, member computing devices 502a through 502n may operate on any operating system capable of supporting a browser or browser-enabled application, such as Microsoft™, Windows™, and/or Linux. In certain embodiments, member computing devices 502a through 502n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 502a through 502n, users, 512a through 512n, may communicate over the exemplary network 506 with each other and/or with other systems and/or devices coupled to the network 506. As shown in FIG. 5, exemplary server devices 504 and 513 may be also coupled to the network 506. Exemplary server device 504 may include a processor 505 coupled to a memory that stores a network engine 517. Exemplary server device 513 may include a processor 514 coupled to a memory 516 that stores a network engine. In some embodiments, one or more member computing devices 502a through 502n may be mobile clients. As shown in FIG. 5, the network 506 may be coupled to a cloud computing/architecture(s) 525. The cloud computing/architecture(s) 525 may include a cloud service coupled to a cloud infrastructure and a cloud platform, where the cloud platform may be coupled to a cloud storage.

In certain embodiments, at least one database of exemplary databases 507 and 515 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In certain embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In certain embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In certain embodiments, the exemplary DBMS-managed database may be specifically programmed to include metadata about the data that is stored.

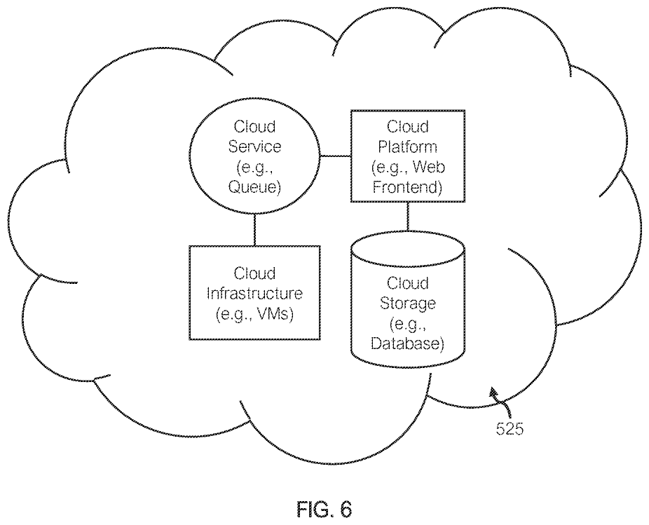

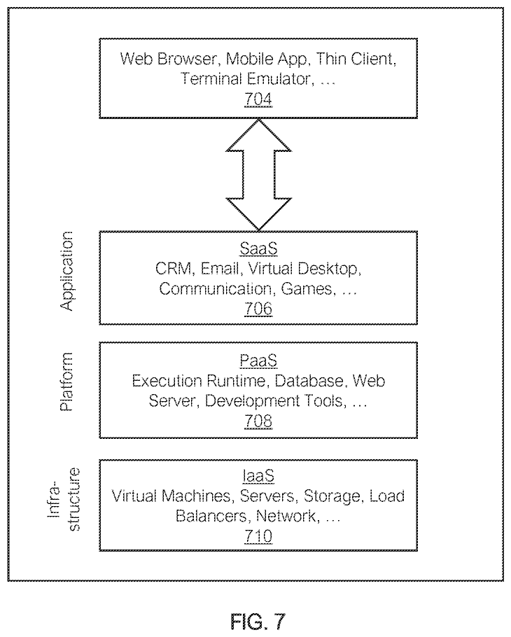

FIG. 6 and FIG. 7 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate. FIG. 6 illustrates an expanded view of the cloud computing/architecture(s) 525 found in FIG. 5. FIG. 7. illustrates the exemplary inventive computer-based components of the present disclosure may be specifically configured to operate in the cloud computing/architecture 525 as a source database 704, where the source database 704 may be a web browser. a mobile application, a thin client, and a terminal emulator. In FIG. 7, the exemplary inventive computer-based systems/platforms, the exemplary inventive computer-based devices, and/or the exemplary inventive computer-based components of the present disclosure may be specifically configured to operate in a cloud computing/architecture such as, but not limiting to: infrastructure a service (IaaS) 710, platform as a service (PaaS) 708, and/or software as a service (SaaS) 706.

In certain embodiments and, optionally, in combination of any embodiment described above or below, an exemplary trained neural network model may be utilized to support the functionality provided by the system 100 and methods, and may specify a neural network by at least a neural network topology, a series of activation functions, and connection weights. For example, the topology of a neural network may include a configuration of nodes of the neural network and connections between such nodes. In certain embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In certain embodiments and, optionally, in combination of any embodiment described above or below, an output of the exemplary aggregation function may be used as input to the exemplary activation function. In certain embodiments and, optionally, in combination of any embodiment described above or below, the bias may be a constant value or function that may be used by the aggregation function and/or the activation function to make the node more or less likely to be activated.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; knowledge corpus; stored audio recordings; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. In some embodiments, the server may store transactions and dynamically trained machine learning models. Cloud servers are examples.

In some embodiments, as detailed herein, one or more of exemplary inventive computer-based systems/platforms, exemplary inventive computer-based devices, and/or exemplary inventive computer-based components of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a social media post, a map, an entire application (e.g., a calculator), etc. In certain embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) FreeBSD™, NetBSD™, OpenBSD™; (2) Linux™; (3) Microsoft Windows™; (4) OS X (MacOS)™; (5) MacOS 11™; (6) Solaris™; (7) Android™; (8) iOS™; (9) Embedded Linux™; (10) Tizen™; (11) WebOS™; (12) IBM i™; (13) IBM AIX™; (14) Binary Runtime Environment for Wireless (BREW)™; (15) Cocoa (API)™; (16) Cocoa Touch™; (17) Java Platforms™; (18) JavaFX™; (19) JavaFX Mobile; TM (20) Microsoft DirectX™; (21).NET Framework™; (22) Silverlight™; (23) Open Web Platform™; (24) Oracle Database™; (25) Qt™; (26) Eclipse Rich Client Platform™; (27) SAP NetWeaver™; (28) Smartface™; and/or (29) Windows Runtime™.

In certain embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device. In at least certain embodiments, the exemplary ASR system of the present disclosure, utilizing at least one machine-learning model described herein, may be referred to as exemplary software.

In certain embodiments, exemplary inventive computer-based systems/platforms, exemplary inventive computer-based devices, and/or exemplary inventive computer-based components of the present disclosure may be configured to handle numerous concurrent tests for software agents and/or numerous streaming or other types of records that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

In some embodiments, exemplary inventive computer-based systems/platforms, exemplary inventive computer-based devices, and/or exemplary inventive computer-based components of the present disclosure may be configured to be utilized in various applications which may include, but not limited to, the exemplary ASR system of the present disclosure, utilizing at least one machine-learning model described herein, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

The aforementioned examples are, of course, illustrative and not restrictive.

At least some aspects of the present disclosure will now be described with reference to the following numbered clauses.
Clause 1. A system may include a memory that stores instructions and a processor that executes the instructions to configure the processor to: receive, by a first function, at least one streaming record, wherein each streaming record of the at least one streaming record may be associated with an event; place, by the first function, the at least one streaming record in a delay queue with a delay timestamp according to a type of the event associated with the at least one streaming record; trigger, in response to placing the at least one streaming record in the delay queue, operation of a second function; determine, by the second function, if a current time is greater than a delay associated with the delay timestamp for the at least one streaming record; requeue, by the second function, the at least one streaming record into the delay queue if the current time is determined to be less than the delay associated with the delay timestamp; place, by the second function, the at least one streaming record into a ready queue if the current time is determined to be equal to or greater than the delay associated with the delay timestamp; and process the at least one streaming record in the ready queue.
Clause 2. The system according to clause 1, wherein the processor is further configured to determine whether the type of the event is an initialization event, a success event, or a recommendation event, and place the at least one streaming record in the delay queue if the type of event is the initialization event or the success event.
Clause 3. The system according to clause 1 or 2, wherein the processor is further configured to prevent the at least one streaming record from being placed in the delay queue if the type of event is the recommendation event.
Clause 4. The system according to clause 1, 2 or 3, wherein the processor is further configured to group the at least one streaming record with at least one other streaming record based on the at least one other streaming record corresponding to the type of the event associated with the at least one streaming record.
Clause 5. The system according to clause 1, 2, 3 or 4, wherein the processor is further configured to trigger, after requeuing the at least one streaming record into the delay queue when the current time is determined to be less than the delay associated with the delay timestamp, the second function to redetermine if a new current time is greater than the delay associated with the delay timestamp for the at least one streaming record.
Clause 6. The system according to clause 1, 2, 3, 4 or 5, wherein the processor is further configured to establish a setting specifying the delay timestamp for the type of the event.
Clause 7. The system according to clause 1, 2, 3, 4, 5 or 6, wherein the processor is further configured to receive a request to modify the setting specifying the delay timestamp for the type of the event and modify the setting to specify a modified delay timestamp for the type of the event based on the request.
Clause 8. The system according to clause 1, 2, 3, 4, 5, 6 or 7, wherein the processor is further configured to specify a delay setting for the second function that indicates a delay in triggering the operation of the second function.
Clause 9. The system according to clause 1, 2, 3, 4, 5, 6, 7 or 8, wherein the system is further configured to delay the triggering of the operation of the second function performed in response to placing the at least one streaming record in the delay queue in accordance with the delay indicated by the delay setting.
Clause 10. The system according to clause 1, 2, 3, 4, 5, 6, 7, 8 or 9, wherein the event is associated with a digital communication to attract a user into subscribing to a product or service, perform an action, or a combination thereof.
Clause 11. The system according to clause 1, 2, 3, 4, 5, 6, 7, 8, 9 or 10, wherein the system is further configured to determine an effectiveness of a digital communication in facilitating interaction by a user with a product or service based on processing the at least one streaming record associated with the event.
Clause 12. The system according to clause 1, 2, 3, 4, 5, 6, 7, 8, 9, 10 or 11, wherein the system is further configured to modify the digital communication based on the effectiveness of the digital communication to generate a modified digital communication, and transmit the modified digital communication to the user, another user, or a combination thereof.
Clause 13. A computer-implemented method may include: receiving, by a first function and by utilizing a processor, at least one streaming record, wherein each streaming record of the at least one streaming record is associated with an event; placing, by the first function and by utilizing the processor, the at least one streaming record in a delay queue with a delay timestamp according to a type of the event associated with the at least one streaming record; triggering, in response to placing the at least one streaming record in the delay queue and by utilizing the processor, operation of a second function; determining, by the second function and by utilizing the processor, if a current time is greater than a delay associated with the delay timestamp for the at least one streaming record; requeuing, by the second function and by utilizing the processor, the at least one streaming record into the delay queue if the current time is determined to be less than the delay associated with the delay timestamp; placing, by the second function and by utilizing the processor, the at least one streaming record into a ready queue if the current time is determined to be equal to or greater than the delay timestamp; and processing, by the processor, the at least one streaming record in the ready queue
Clause 14. The computer-implemented method according to clause 13, further comprising determining the type of the event associated with the at least one streaming record.
Clause 15. The computer-implemented method according to clause 13 or 14, further comprising triggering, after requeuing the at least one streaming record into the delay queue when the current time is determined to be less than the delay associated with the delay timestamp, the second function to redetermine if a new current time is greater than the delay associated with the delay timestamp for the at least one streaming record.
Clause 16. The computer-implemented method according to clause 13, 14 or 15, further comprising specifying a delay for the second function that indicates when to trigger the operation of the second function.
Clause 17. The computer-implemented method according to clause 13, 14, 15 or 16, further comprising preventing the at least one streaming record from being placed in the delay queue if the type of event is a recommendation event.
Clause 18. The computer-implemented method according to clause 13, 14, 15, 16 or 17, further comprising placing the at least one streaming record from in the delay queue if the type of event is an initialization event or a success event.
Clause 19. The computer-implemented method according to clause 13, 14, 15, 16, 17 or 18, further comprising triggering the operation of the first function, the second function, or a combination thereof, based on a preference.
Clause 20. A non-transitory computer-readable medium comprising computer instructions, which, when loaded and executed by a processor, cause the processor to be configured to: receive, by a first function, at least one streaming record, wherein each streaming record of the at least one streaming record is associated with an event; place, by the first function, the at least one streaming record in a delay queue with a delay timestamp according to a type of the event associated with the at least one streaming record; trigger, in response to placing the at least one streaming record in the delay queue, operation of a second function; determine, by the second function, if a current time is greater than a delay associated with the delay timestamp for the at least one streaming record; requeue, by the second function, the at least one streaming record into the delay queue if the current time is determined to be less than the delay associated with the delay timestamp; place, by the second function, the at least one streaming record into a ready queue if the current time is determined to be equal to or greater than the delay timestamp; and process the at least one streaming record in the ready queue.

While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

What is claimed is:

1. A system, comprising:
a memory that stores instructions; and
a processor that executes the instructions to cause the processor to be configured to:
receive, by a first function, at least one streaming record, wherein each streaming record of the at least one streaming record is associated with an event;
place, by the first function, the at least one streaming record in a delay queue with a delay timestamp according to a type of the event associated with the at least one streaming record;
trigger, in response to placing the at least one streaming record in the delay queue, operation of a second function;
determine, by the second function, if a current time is greater than a delay associated with the delay timestamp for the at least one streaming record;
requeue, by the second function, the at least one streaming record into the delay queue if the current time is determined to be less than the delay;
place, by the second function, the at least one streaming record into a ready queue if the current time is determined to be equal to or greater than the delay; and
process the at least one streaming record in the ready queue.

2. The system of claim 1, wherein the processor is further configured to:
determine whether the type of the event is an initialization event, a success event, or a recommendation event; and
place the at least one streaming record in the delay queue if the type of event is the initialization event or the success event.

3. The system of claim 2, wherein the processor is further configured to:
prevent the at least one streaming record from being placed in the delay queue if the type of event is the recommendation event.

4. The system of claim 1, wherein the processor is further configured to:
group the at least one streaming record with at least one other streaming record based on the at least one other streaming record corresponding to the type of the event associated with the at least one streaming record.

5. The system of claim 1, wherein the processor is further configured to:
trigger, after requeuing the at least one streaming record into the delay queue when the current time is determined to be less than the delay associated with delay timestamp, the second function to redetermine if a new current time is greater than the delay associated with the delay timestamp for the at least one streaming record.

6. The system of claim 1, wherein the processor is further configured to:
establish a setting specifying the delay timestamp for the type of the event.

7. The system of claim 6, wherein the processor is further configured to:
receive a request to modify the setting specifying the delay timestamp for the type of the event; and
modify the setting to specify a modified delay timestamp for the type of the event based on the request.

8. The system of claim 1, wherein the processor is further configured to:
specify a delay setting for the second function that indicates a delay in triggering the operation of the second function.

9. The system of claim 8, wherein the processor is further configured to:
delay triggering of the operation of the second function performed in response to placing the at least one streaming record in the delay queue in accordance with the delay indicated by the delay setting.

10. The system of claim 1, wherein the event is associated with a digital communication to attract a user into subscribing to a product or service, perform an action, or a combination thereof.

11. The system of claim 1, wherein the processor is further configured to:
determine an effectiveness of a digital communication in facilitating interaction by a user with a product or service based on processing the at least one streaming record associated with the event.

12. The system of claim 11, wherein the processor is further configured to:
modify the digital communication based on the effectiveness of the digital communication to generate a modified digital communication; and
transmit the modified digital communication to the user, another user, or a combination thereof.

13. A computer-implemented method, comprising:
receiving, by a first function and by utilizing a processor, at least one streaming record, wherein each streaming record of the at least one streaming record is associated with an event;
placing, by the first function and by utilizing the processor, the at least one streaming record in a delay queue with a delay timestamp according to a type of the event associated with the at least one streaming record;
triggering, in response to placing the at least one streaming record in the delay queue and by utilizing the processor, operation of a second function;
determining, by the second function and by utilizing the processor, if a current time is greater than a delay associated with the delay timestamp for the at least one streaming record;
requeuing, by the second function and by utilizing the processor, the at least one streaming record into the delay queue if the current time is determined to be less than the delay associated with the delay timestamp;
placing, by the second function and by utilizing the processor, the at least one streaming record into a ready queue if the current time is determined to be equal to or greater than the delay associated with the delay timestamp; and
processing, by the processor, the at least one streaming record in the ready queue.

14. The computer-implemented method of claim 13, further comprising determining the type of the event associated with the at least one streaming record.

15. The computer-implemented method of claim 14, further comprising triggering, after requeuing the at least one streaming record into the delay queue when the current time is determined to be less than the delay associated with the delay timestamp, the second function to redetermine if a new current time is greater than the delay associated with the delay timestamp for the at least one streaming record.

16. The computer-implemented method of claim 13, further comprising specifying a delay for the second function that indicates when to trigger the operation of the second function.

17. The computer-implemented method of claim 13, further comprising preventing the at least one streaming record from being placed in the delay queue if the type of event is a recommendation event.

18. The computer-implemented method of claim 13, further comprising placing the at least one streaming record from in the delay queue if the type of event is an initialization event or a success event.

19. The computer-implemented method of claim 13, further comprising triggering the operation of the first function, the second function, or a combination thereof, based on a preference.

20. A non-transitory computer-readable medium comprising computer instructions, which, when loaded and executed by a processor, cause the processor to be configured to:
receive, by a first function, at least one streaming record, wherein each streaming record of the at least one streaming record is associated with an event;
place, by the first function, the at least one streaming record in a delay queue with a delay timestamp according to a type of the event associated with the at least one streaming record;
trigger, in response to placing the at least one streaming record in the delay queue, operation of a second function;
determine, by the second function, if a current time is greater than a delay associated with the delay timestamp for the at least one streaming record;
requeue, by the second function, the at least one streaming record into the delay queue if the current time is determined to be less than the delay associated with the delay timestamp;
place, by the second function, the at least one streaming record into a ready queue if the current time is determined to be equal to or greater than the delay associated with the delay timestamp; and
process the at least one streaming record in the ready queue.
